(19) United States
(12) Patent Application Publication
(10) Pub. No.: US 2005/0134050 A1
(43) Pub. Date: Jun. 23, 2005

(54) Offshore energy platform

(76) Inventor: Darwin Aldis Salls JR., Gainesville, FL (US)

Correspondence Address: Darwin A. Salls Jr., 5861 S.W. 103rd Street Road, P.O. Box 770126, Ocala, FL, 34476-9375, US

(21) Appl. No.: 10/601,296

(22) Filed: Dec. 18, 2003

(51) Int. Cl. H02P 9/04; F03B 13/00; F03D 9/00

(52) U.S. Cl. 290/54

(57) ABSTRACT

A method and means to generate electrical energy offshore by combining a known type of wind driven turbine and a known type of subsurface water current driven turbine, which are attached to a common rigid offshore structure. The structure consists of a subsurface base (14) where supports (11, 12) are attached. The above surface section of the common structure consists of one or more platforms (16, 18) for mounting a remote generator (19) and a wind turbine tower (21) which supports a known type of wind driven turbine (22) and generator (20). The subsurface section of the common structure supports a known type of water current driven turbine (7, 8, 9, 10, 15, 23, 25). This combination of both a wind driven turbine and a water current driven turbine, using a common offshore rigid structure will have the generating capacity to generate two to three times more energy than separate stand alone systems.

### STATEMENT REGARDING FEDERALLY SPONSORED RESEARCH OR DEVELOPMENT

Applicant has not received any federally sponsored research or development assistance.

### REFERENCE TO A MICROFICHE APPENDIX

Applicant does not have a microfiche appendix.

### BACKGROUND OF THE INVENTION

1. Field of Invention

Applicant's invention relates to a new use field method and means to generate electrical energy by combining a known type of wind driven turbine and a known type of subsurface water current driven turbine together on a common offshore structure to produce electrical energy.

2. Description of Related Art

There are several designs of energy generating systems such as the windmill type wind turbine generator which is usually set upon a tower on land, and more recently offshore. The offshore wind turbines are considered more efficient than land based wind turbines. There are several hydroelectric turbines that use stored water from dams, rivers, wave action, and water current kinetic energy, such as the subsurface hydrokinetic generator, U.S. Pat. No. 6,472,768, to generate electrical energy. A combination of a wind turbine and ocean swell powered generator called a Wind and Ocean Swell Power or WOSP, which exists in the United Kingdom and works by ocean wave action and wind power.

Applicant's offshore energy platform combines a wind turbine and a subsurface hydrokinetic generator, driven by water currents such as the Gulf Stream, and wind power.

### BRIEF SUMMARY OF THE INVENTION

A method and means for generating electrical energy via an offshore energy platform using an attached wind driven turbine and a subsurface water current driven turbine.

Applicant's offshore energy platform consists of a subsurface structure extending from the ocean floor to a platform above the surface. The subsurface structure would support a subsurface water current driven turbine and the structure above the surface would support a tower and wind driven turbine. The entire structure would have to be rigid enough to support both turbines and there respective applied forces of wind and water current. While the water driven turbine below the surface would have to face the direction of the oncoming water current force, the wind driven turbine atop the platform tower above the surface, would be omnidirectional and adjust to the oncoming wind directional force.

The offshore energy platform would be connected to an onshore power grid through subsurface electrical cable. Theoretically, the offshore energy platform should generate two to three times more energy than either stand-a-lone systems, additionally, each platform could be used for, marine navigation aids, communication towers, environmental monitoring stations, and provide early warning stations which monitor offshore water craft and low altitude air traffic.

Further objects and advantages of Applicant's offshore energy platform will become apparent from a consideration of the drawings and ensuing description.

### DRAWINGS

### Brief Description of the Drawings

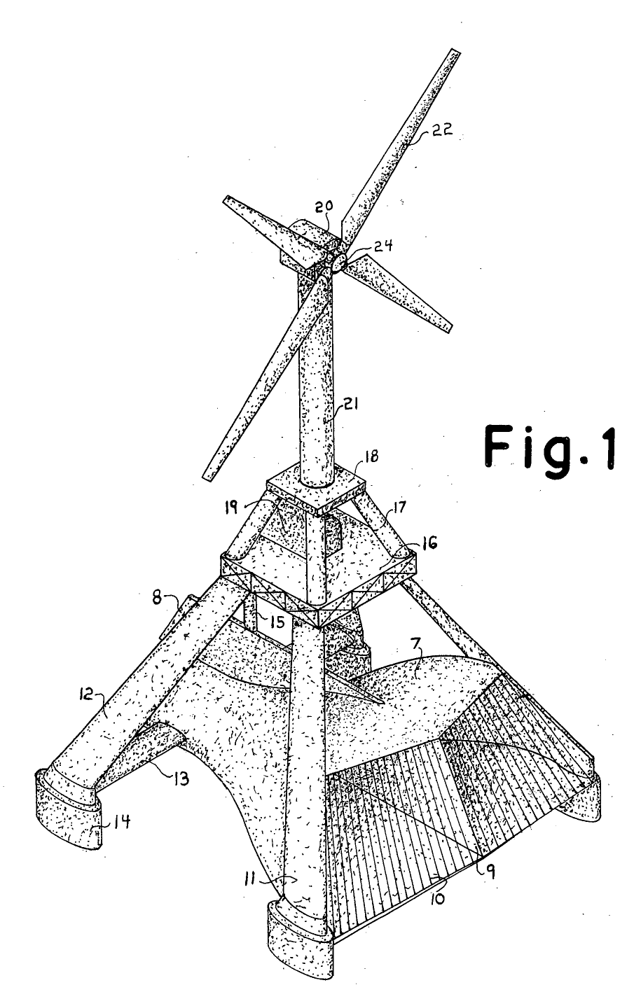

FIG. 1: A perspective view.

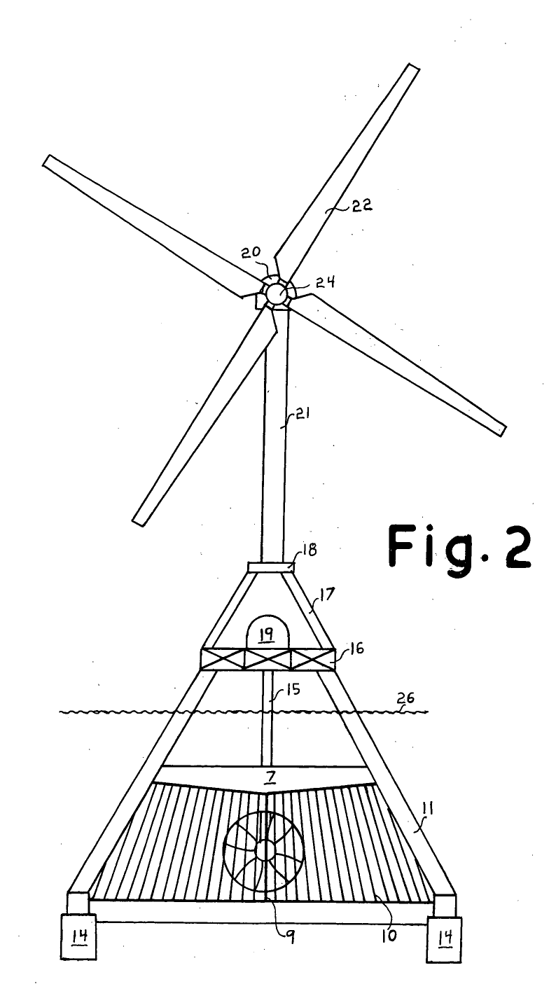

FIG. 2: A front view.

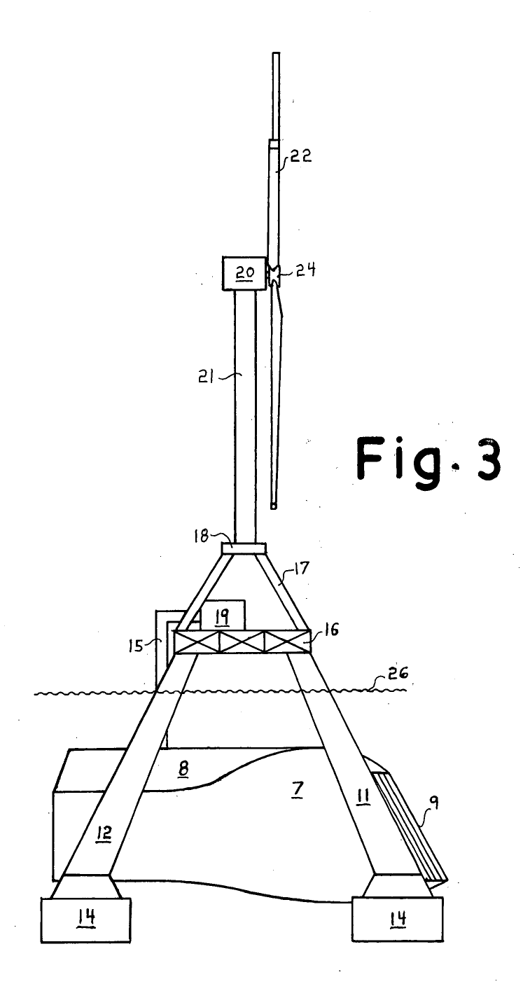

FIG. 3: A side view.

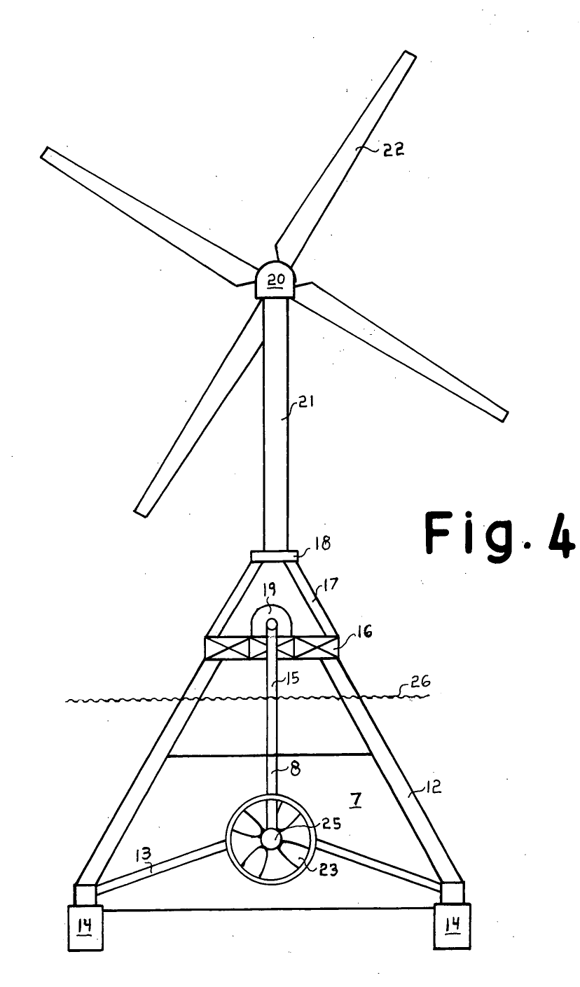

FIG. 4: A rear view.

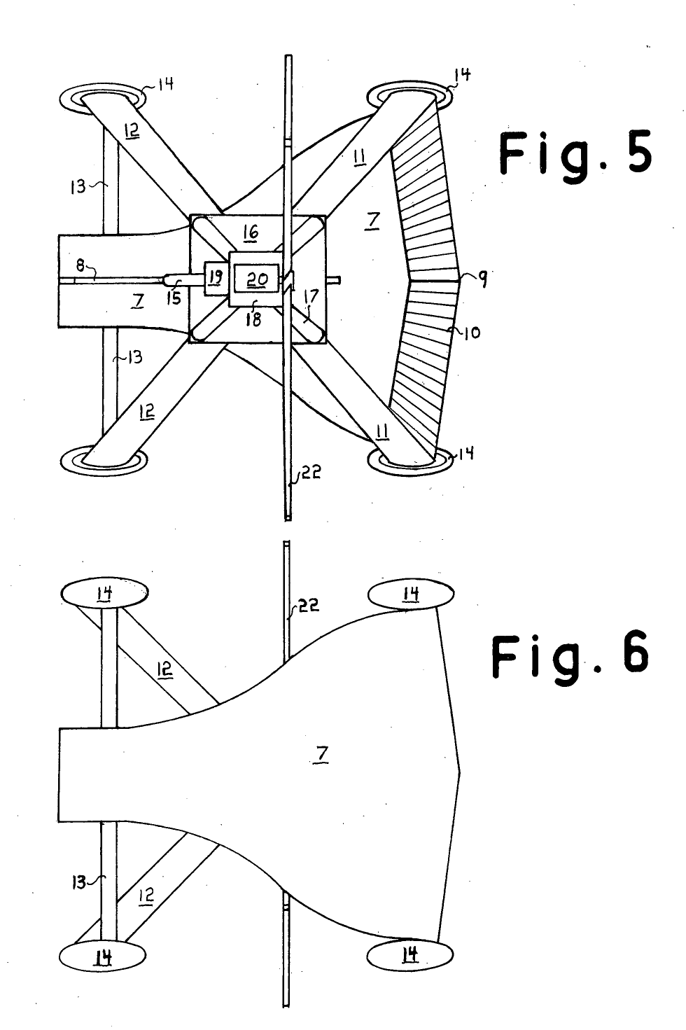

FIG. 5: A top view.

FIG. 6: A bottom view.

### ELEMENTS OF THE FIGURES

No.: 7—Hydrokinetic Generator Housing
No.: 8—Vertical Stabilizer
No.: 9—Vertical Center Support
No.: 10—Protective Grill
No.: 11—Front Supports
No.: 12—Rear Supports
No.: 13—Rear Housing Supports
No.: 14—Platform Base
No.: 15—Vertical Drive Shaft Housing
No.: 16—Main Platform
No.: 17—Upper Platform Supports
No.: 18—Upper Platform
No.: 19—Remote Generator
No.: 20—Wind Turbine Generator
No.: 21—Wind Turbine Tower
No.: 22—Wind Turbine Blades
No.: 23—Water Turbine Blades
No.: 24—Wind Turbine Hub
No.: 25—Water Turbine Hub
No.: 26—Water Surface Line

### DETAILED DESCRIPTION OF THE INVENTION

FIG. 1: A perspective view of the offshore energy platform detailing the main platform 16 and its superstructure. The main platform 16 is supported by two front supports 11 which are attached to the base 14, and support the front of the hydrokinetic generator housing 7. Two rear supports 12 are also supporting the rear of the hydrokinetic generator housing 7 by rear housing supports 13. The front supports 11 and the rear supports 12 are hydrodynamically shaped to produce minimal drag and must face the oncoming water current. The subsurface hydrokinetic generator housing 7 has a vertical stabilizer 8 to aid in keeping the hydrokinetic generator housing 7 facing the water current. There is a vertical center support 9 which provides strength for the hydrokinetic generator 7 and the protective grill 10 to keep debris and large sea life from entering the housing orfice. A vertical drive shaft housing 15 houses a drive shaft and is hydrodynamically shaped to reduce drag. The drive shaft transfers rotational energy from the hydrokinetic generator turbine to a remote generator 19 mounted on the main platform 16. The hydrokinetic generator can be mounted below the surface and attached to the hydrokinetic generator housing 7. Upper platform supports 17 support an upper platform 18, which supports the wind turbine tower 21. The wind turbine tower 21 can be mounted to the lower main platform 16, and the upper platform 18 and the upper platform supports 17 can be eliminated. The wind turbine tower 21 supports a wind turbine generator 20 which has wind turbine blades 22 attached to the wind turbine generator 20 by a wind turbine hub 24. Both generators are connected to an onshore power grid by subsurface electrical cables. Different wind turbines can be used which differ from the illustrated wind turbine, such as the Darrieus vertical axis wind turbine. Different subsurface turbines can be used instead of the hydrokinetic generator illustrated, such as a single propeller, or the Gorlov Helical turbine for examples.

FIG. 2: A front view of the offshore energy platform detailing the hydrokinetic generator housing 7 attached to the front supports 11 which are connected to the platform base 14. The vertical center support 9 strengthens the hydrokinetic generator housing 7 orfice. The protective grill 10 keeps debris and large sea life from entering the orfice. A vertical drive shaft housing 15 protects the drive shaft which transfers rotational energy to the remote generator 19 which is attached to the main platform 16. Upper platform supports 17 support the upper platform 18. The wind turbine tower 21 is attached to the upper platform 18, and supports the wind turbine generator 20. Wind turbine blades 22 are attached to the wind turbine generator 20 by a wind turbine hub 24. The water surface line 26 shows the water level in relation to the platform.

FIG. 3: A side view of the offshore energy platform detailing the platform bases 14 which are hydrodynamically shaped to produce minimal drag yet rigid enough to withstand the dual forces applied. Front supports 11 are hydrodynamically shaped to produce minimal drag and rigid enough to support the hydrokinetic generator housing 7, which is also hydrodynamically shaped. Rear supports 12 are hydrodynamically shaped to produce minimal drag and support the rear of the hydrokinetic generator housing 7. The vertical center support 9 supports the hydrokinetic generator housing 7, and the protective grill 10 keeps debris and large sea life from entering the housing orfice. A vertical stabilizer 8 keeps the hydrokinetic generator housing 7 aligned with the oncoming water current and aid in attaching the housing to the subsurface structure of the offshore energy platform. A vertical drive shaft housing 15 protects the drive shaft which transfers rotational energy from the subsurface turbine to the remote generator 19 located on the main platform 16. Upper platform supports 17 support the upper platform 18, which attaches the wind turbine tower 21 to the platform. The wind turbine generator 20 sets atop the wind turbine tower 21 and is connected to the wind turbine blades 22 by a wind turbine hub 24. An alternative system could use a common generator for both turbines. The water surface line 26 shows the level of the water in relation to the offshore energy platform.

FIG. 4: A rear view of the offshore energy platform detailing the platform bases 14, with the attached rear supports 12. The rear of the hydrokinetic generator housing 7 is supported by the rear housing supports 13. The water turbine blades 23 are attached to the water turbine hub 25. A drive shaft transfers rotational energy from the water turbine blades 23, to the remote generator 19 through a vertical drive shaft housing 15. The vertical stabilizer 8 is the same width as the vertical drive shaft housing 15 which passes through the vertical stabilizer 8 to the water turbine hub 25. The remote generator 19 is attached to the main platform 16 in which the upper platform 18 is attached to the main platform 16 by upper platform supports 17. A wind turbine tower 21 is attached to the upper platform 18. A wind turbine generator 20 sets atop of the wind turbine tower 21, and is connected to the wind turbine blades 22 by a wind turbine hub 24. The water surface line 26 shows the water level in relation to the offshore energy platform.

FIG. 5: A top view of the offshore energy platform detailing the wind turbine blades 22 attached to the wind turbine generator 20. Upper platform 18 supports the wind turbine tower with the wind turbine generator 20 atop. Upper platform supports 17 are attached to the main platform 16, on which also rests the remote generator 19 which is driven by a drive shaft protected by a vertical drive shaft housing 15. The drive shaft housing 15 passes through the vertical stabilizer 8 to the water turbine housed in the hydrodynamically shaped hydrokinetic generator housing 7. A vertical center support 9 supports the housing orfice and the protective grill 10 keeps debris and large sea life from entering the housing orfice. The hydrokinetic generator housing 7 is attached to the front supports 11 which are attached to the platform bases 14. The rear of the hydrokinetic generator housing 7 is attached to the rear supports 12 by rear housing supports 13. Rear supports are connected to the platform bases 14.

FIG. 6: A bottom view of the offshore energy platform detailing the platform bases 14, which support the front supports 11 and rear supports 12 which support the hydrodynamically shaped hydrokinetic generator housing 7 by the rear housing supports 13.

1. An offshore energy platform comprising;
a. a rigid structure having at least one above surface platform and attached by attachment means to a stationary subsurface medium;
b. said rigid structure having means to support a subsurface water current driven turbine capable of producing rotational energy;
c. the rigid structure having additional means to support an above surface wind driven turbine capable of producing rotational energy;
d. said water current driven turbine and said wind driven turbine attached by attachment means to electrical energy producing generators;
e. said electrical energy producing generators attached by attachment means to an electrical grid in order to transfer electrical energy from the electrical energy producing generators to one or more user recipients.

2. An offshore energy platform of claim 1, wherein multiple subsurface water current driven turbines are attached by attachment means to the substructure of said offshore energy platform.

3. An offshore energy platform of claim 1, wherein multiple above surface wind driven turbines are attached by attachment means to one or more above surface platforms.

4. An offshore energy platform of claim 1, wherein a subsurface water current driven turbine and an above surface wind driven turbine share a common electrical energy producing generator.

5. An offshore energy platform of claim 1, wherein said rigid structure is buoyant and attached by attachment means to a stationary subsurface medium using one or more cables.
